(19) United States
(12) Patent Application Publication
(10) Pub. No.: US 2020/0214288 A1
(43) Pub. Date: Jul. 9, 2020

(54) SPORICIDAL DISINFECTANT

(71) Applicant: PROFESSIONAL DISPOSABLES INTERNATIONAL, INC., Orangeburg, NY (US)

(72) Inventor: Luke Kwabena Osei-Owusu, Bronx, NY (US)

(73) Assignee: PROFESSIONAL DISPOSABLES INTERNATIONAL, INC., Orangeburg, NY (US)

(21) Appl. No.: 16/624,585

(22) PCT Filed: Jun. 22, 2018
(86) PCT No.: PCT/US2018/039070

§ 371 Date: Dec. 19, 2019

Related U.S. Application Data
(60) Provisional application No. 62/524,047, filed on Jun. 23, 2017.

(51) Int. Cl. A01N 37/20; A01N 25/22; A01N 25/34; A01N 25/02; A01N 59/00

(52) U.S. Cl. CPC A01N 37/20; A01N 25/22; A01N 59/00; A01N 25/02; A01N 25/34

(57) ABSTRACT

Stable, low odor, hospital grade, non-bleach, decontaminating sporicidal disinfectant compositions and consumer products comprising such compositions are provided. The sporicidal disinfectant compositions comprise hydrogen peroxide and tetraacetylethylenediamine (TAED) and provide a solution of peracetic acid (PAA) for use in decontaminating articles and surfaces. Methods of preparing and applying consumer products, such as disinfecting sprays and ready-to-use wipes, are also provided.

### CROSS-REFERENCE TO RELATED APPLICATIONS

This application is a U.S. national stage entry under 35 U.S.C. § 371 of International Patent Application No.: PCT/US2018/039070, filed on Jun. 22, 2018, which claims priority to U.S. Provisional Application No. 62/524,047, filed on Jun. 23, 2017, the contents of each of which is incorporated herein by reference in their entireties.

### 1. FIELD

The presently disclosed subject matter relates to stable, low odor, hospital grade, non-bleach, decontaminating sporicidal disinfectants. Specifically, the present disclosure is directed to disinfectant compositions comprising hydrogen peroxide and tetraacetylethylenediamine (TAED) for use in decontaminating articles and surfaces of bacteria, viruses, fungi, and other chemical or biological contaminants.

### 2. BACKGROUND

In recent years, there has been an on-going effort within the healthcare industry to improve the stability, user-friendliness, sustainability, and environmental profile of sporicidal decontaminating products. There is on-going interest in hospitals, laboratories, clinics, and research and manufacturing facilities for a cleaning product with improved sporicidal efficacy that can be used to disinfect, sterilize, and decontaminate articles and hard surfaces from viruses, fungi, and other chemical or biological contaminants, including, but not limited to, spores such as Clostridium difficile (C. diff). Infection with C. diff can be life-threatening to many patient populations. The contamination of equipment, materials, and surfaces with spores produced by C. diff bacteria occurs frequently, despite the best efforts at infection control.

Sporicidal decontaminating products are available commercially and generally utilize peroxygen sources—such as hydrogen peroxide—and acetyl donors—such as tetraacetylethylenediamine (TAED)—to generate peracetic acid (PAA) as a disinfectant or sterilant. PAA is a well-known organic peroxide, and is widely used because of its excellent cleaning and disinfection properties. However, while commercially available products containing PAA are effective in part, they also have various disadvantages. For one, there are safety and handling concerns due to the highly corrosive and highly flammable properties of PAA. PAA has a low flash point of 40° C., which can result in a fire or explosion if the product is not stored properly. Liquid peracetic acid is extremely unstable and must be separately packaged from other compounds of a disinfectant formula. Even with separate packaging, products containing peracetic acid tend to have a very limited shelf life. Moreover, in formulations combining hydrogen peroxide and TAED to produce PAA, the hydrogen peroxide, when combined with TAED, becomes unstable and converts to water. As such, existing products require hydrogen peroxide and TAED to be separately housed in different chambers before use. Additionally, PAA has a very distinct and strong vinegar smell that is not appealing to consumers.

In areas such as the health care market and pharmaceutical industry, an EPA-approved cleaning composition that is effective against contaminants such as C. diff is still needed. Thus, there remains a need in the art for a sporicidal disinfectant product having lower to no adverse odor and better stability and shelf life that avoids onerous handling and storage parameters than currently existing products, while also overcoming the requirement to separate hydrogen peroxide and TAED until immediately before use to avoid undesirable side reactions. The presently disclosed subject matter addresses these and other needs as discussed in detail below.

### 3. SUMMARY OF THE INVENTION

The presently disclosed subject matter provides sporicidal disinfectants comprising hydrogen peroxide and tetraacetylethylenediamine (TAED) It was surprisingly found that compositions uniquely formulated with these components avoided undesirable side reactions, and provided an aqueous solution of peracetic acid for use in decontaminating articles and surfaces, while simultaneously exhibiting prolonged stability without an unpleasant, strong vinegar smell.

In certain embodiments, the present disclosure provides a sporicidal disinfectant composition comprising hydrogen peroxide and tetraacetylethylenediamine (TAED), formulated as a single solution. In some embodiments, the sporicidal disinfectant composition is comprised of between about 0.1 wt % and about 60 wt % hydrogen peroxide. In other embodiments, hydrogen peroxide is about 8 wt % of the composition. In certain embodiments, the sporicidal disinfectant composition is comprised of between about 0.01 wt % and about 20 wt % TAED In certain embodiments, TAED is about 2 wt % of the composition.

In certain embodiments, the present disclosure provides a sporicidal disinfectant composition that reduces the amount of Clostridium difficile (C. diff) on an article or on a surface by at least 99.9999% in about 3 minutes.

In certain embodiments, the present disclosure provides a sporicidal disinfectant composition further comprising a buffer system. In some embodiments, the buffer system is about 0.01 wt % to about 5 wt % of the composition. In some embodiments, the buffer system comprises sodium carbonate. In certain embodiments, the sodium carbonate is about 0.6 wt % of the composition. In other embodiments, the buffer system comprises sodium citrate. In certain embodiments, the sodium citrate is about 0.45 wt % of the composition.

In certain embodiments, the present disclosure provides a sporicidal disinfectant composition further comprising a pH adjuster. In some embodiments, the pH adjuster is selected from the group consisting of acetic acid, citric acid, and combinations thereof. In certain embodiments, the pH adjuster comprises acetic acid and citric acid. In some embodiments, the pH adjuster comprises about 0.01 wt % to about 10 wt % acetic acid and about 0.01 wt % to about 5 wt % citric acid relative to the total composition. In other embodiments, the acetic acid is about 0.05 wt % of the composition and the citric acid is about 0.14 wt % of the composition. In certain embodiments, the acetic acid is about 0.05 wt % of the composition and the citric acid is about 0.10 wt % of the composition.

In certain embodiments, the present disclosure provides a sporicidal disinfectant composition further comprising a stabilizer. In some embodiments, the stabilizer comprises hydroxyethane 1,1-diphosphonic acid (HEDP). In certain embodiments, the stabilizer is about 0.01 wt % to about 5 wt % of the composition. In certain embodiments, the stabilizer is about 0.55 wt % of the composition.

The present disclosure also provides a consumer product comprising the sporicidal disinfectant composition disclosed herein. In certain embodiments, the consumer product comprises at least one of a sporicidal disinfectant spray or a sporicidal disinfectant wipe. In certain embodiments, the sporicidal disinfectant spray comprises an apparatus for applying the sporicidal disinfectant composition to a surface.

The present disclosure further provides a method of disinfecting an article or surface comprising treating said article or surface with the sporicidal disinfectant composition herein disclosed.

The foregoing has outlined broadly the features and technical advantages of the present application in order that the detailed description that follows can be better understood. Additional features and advantages of the application will be described hereinafter which form the subject of the claims of the application. It should be appreciated by those skilled in the art that the conception and specific embodiment disclosed can be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### 4. BRIEF DESCRIPTION OF THE DRAWINGS

FIG. 1 provides a graphical representation of the changes in weight percent of hydrogen peroxide in a sporicidal disinfecting composition (y-axis) over a period of about two weeks (x-axis) and at a high temperature of 54° C.

### 5. DETAILED DESCRIPTION

As noted above, there remains a need in the art for sporicidal disinfecting peracetic acid (PAA) products comprising hydrogen peroxide and tetraacetylethylenediamine (TAED) that have little to no odor adverse to consumers and better stability and shelf life. The presently disclosed subject matter provides a novel and unique manufacturing process—by inclusion of a buffer system and a stabilizer. Such techniques are an improvement to current commercially available products by providing one single formulation comprising hydrogen peroxide with TAED that is stable. Further, the residual end products are biodegradable.

### 5.1. Definitions

The terms used in this specification generally have their ordinary meanings in the art, within the context of this disclosed subject matter and in the specific context where each term is used. Certain terms are discussed below, or elsewhere in the specification, to provide additional guidance to the practitioner in describing the compositions and methods of the disclosed subject matter and how to make and use them.

As used herein, the use of the word “a” or “an” when used in conjunction with the term “comprising” in the claims and/or the specification can mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value.

The term “solvent” is used herein to connote a liquid portion that may be added to one or more components described herein. The term “solvent” is not meant to require that the solvent material be capable of actually dissolving all of the components to which it is added.

The term “compartment” or “chamber” refers to any section or part of a space, such as a container, that divides the space so that there are multiple separate spaces within the container.

The term “composition” refers to any solution, compound, formulation, or mixture with at least two ingredients. The ingredients may be, for example, chemicals, substances, molecules, or compositions.

The term “additive” refers to any substance, chemical, or compound that is added to an initial substance, chemical, or compound in a smaller amount than the initial substance, chemical, or compound to provide additional properties or to change the properties of the initial substance, chemical, or compound.

The term “bleaching compound” refers to any compound that removes color, whitens, sterilizes, and/or disinfects a product.

The term “buffer” refers to any chemical, compound, or solution that is used to control the pH of a composition, system, or solution. A “buffer system” refers to any composition or system where there are two or more components that are used to control the pH of a composition, system, or solution, such as an acid and a base. The components are any chemical, compound, or solution.

Unless otherwise specified, all percentages used herein are weight percents.

### 5.2. Hydrogen Peroxide

Hydrogen peroxide (H₂O₂) in its pure form, it is a colorless liquid, slightly more viscous than water. Hydrogen peroxide is the simplest peroxide, a compound with an oxygen-oxygen single bond. It is used as an oxidizer, bleaching agent, and disinfectant. However, hydrogen peroxide is unstable and decomposes to form water and oxygen:

2 H₂O₂→2 H₂O+O₂

The decomposition of hydrogen peroxide liberates oxygen and heat, which can be dangerous. Hydrogen peroxide is used for pulp- and paper-bleaching and in the manufacture of sodium percarbonate and sodium perborate which are used as mild bleaches in laundry detergents.

### 5.3. Tetraacetylethylenediamine (TAED)

In the presently disclosed subject matter, hydrogen peroxide is combined with tetraacetylethylenediamine (TAED) to produce peracetic acid (PAA), which can then be used for the sterilization of various surfaces, including surgical tools.

Tetraacetylethylenediamine ((CH₃CO)₂NCH₂CH₂N(COCH₃)₂) is a white solid commonly used as a bleach activator in laundry detergents and for paper pulp. It is produced by acetylation of ethylenediamine:

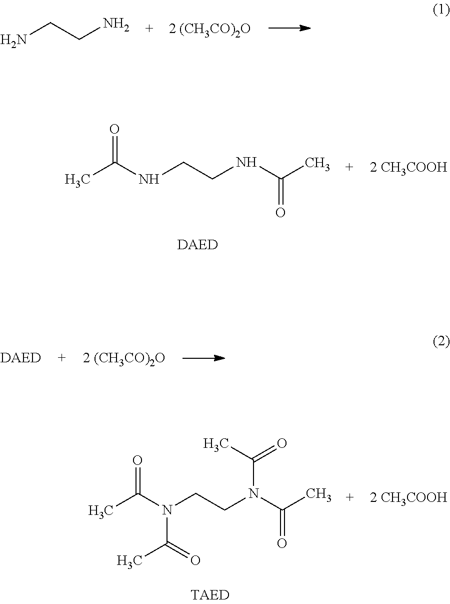

TAED, as well as diacetylethylenediamine (DAED) and triacetylethylenediamine (TriAED), have low toxicity. TAED, TriAED, and DAED are all completely biodegradable.

TAED is an important component of laundry detergents that use active oxygen bleaching agents, such as sodium perborate, sodium percarbonate, sodium perphosphate, sodium persulfate, and urea peroxide. These compounds release hydrogen peroxide during a wash cycle. However, hydrogen peroxide alone is an inefficient bleach below 60° C. (140° F.), but TAED and hydrogen peroxide together form peroxyacetic acid (PAA), which is a more efficient bleach that can allow for lower temperature wash cycles, around 40° C. (104° F.). The present disclosure produces PAA from hydrogen peroxide and TAED in a unique and novel process that allows the two reactants to be in one single formulation with prolonged shelf life.

### 5.4. Peracetic Acid (PAA)

The general chemistry that forms the base of the presently disclosed subject matter is peracetic acid (PAA). PAA is generated from the combination of an acetyl donor, such as TAED, and hydrogen peroxide at a preferably alkaline pH, and is the source of antimicrobial and sporicidal efficacy. Both TAED and hydrogen peroxide are recognized by the Environmental Protection Agency (EPA) as active ingredients.

Peracetic acid can be created in situ by reaction of a weaker bleach compound, such as hydrogen peroxide, or sodium percarbonate, sodium perborate, and other similar oxygen carrying derivatives, and a bleach activator, such as tetraacetylethylenediamine (TAED), as shown in the reaction below:

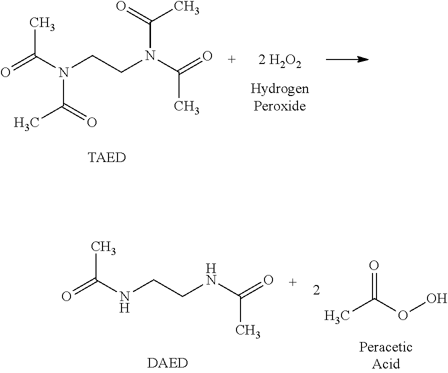

Formulations comprising peracetic acid are effective sporicides. Product formulations containing peracetic and/or components for generating peracetic acid are known in the art. Systems comprising dry components exist that utilize solid peroxygen sources and acetyl donors, which, when mixed with water, produce peracetic acid. (See e.g., U.S. Pat. No. 5,350,563 directed to a two-part perborate/acetyl donor powdered formulation.) While dry product forms have application in certain cases and have an advantage of a longer shelf life and good safety profile, they are generally limited by slow generation of PAA at room temperature. There is a preference for more rapid acting liquid products in certain applications. In addition, a particular disadvantage to multi-component dry systems is that the components dissolve very slowly in water, such that the desired concentration of active ingredients is not fully available until later stages.

On the other hand, a system or formulation utilizing a liquid hydrogen peroxide component has been found to generate PAA much faster, and is available immediately upon combination with an acetyl donor, regardless of whether the acetyl donor is in solid or liquid form. Liquid systems for generating PAA are also known. (See, e.g., U.S. Pat. Nos. 6,514,509 and 7,235,252 directed to systems for preparing organic peroxy acids using a parent solution and activator and requiring a hydroalcoholic environment with an acid pH). Most commercially available PAA-containing products require the use of acetic acid to stabilize the peracetic acid for longer shelf life, greatly increasing the odor profile.

In contrast, the present disclosure does not utilize or require a hydroalcoholic environment and does not have a strong displeasing odor profile. More importantly, the components of the presently disclosed subject matter do not require separate packaging, and are truly ready-to-use because they do not require an additional combination step. The present disclosure requires no further dilution or manipulation of components. Generation of peracetic acid is much faster due to the immediate availability of liquid hydrogen peroxide and dissolved TAED Surprisingly, the present formulations also exhibit longer stability beyond the 14-day requirement by the EPA. The presently disclosed subject matter is an improvement to currently existing commercial products by offering a stable hydrogen peroxide-TAED composition that gives cleaning and disinfection results while avoiding unpleasant vinegar odors.

### 5.5. Stabilizer

The present disclosure can incorporate use of a stabilizer in the reaction between hydrogen peroxide and TAED to produce PAA. Stabilizers include but are not limited to 1-hydroxyethane 1,1-diphosphonic acid (HEDP), sodium stannate, sodium nitrate, and diethylene triamine penta(methylenephosphonic acid). Of note, HEDP is frequently used as a stabilizer in detergents, water treatment, cosmetics, and pharmaceutical treatment to prevent degradation of peroxides. Commercially available forms of HEDP include but are not limited to Dequest 2010, Dequest 2010LC, Briquest ADPA-60A, and Mayoquest 1500.

### 5.6. Buffer System and pH Adjuster

The present disclosure includes a buffer system, which adjusts pH of the presently disclosed sporicidal disinfectant formulations. The buffer system can have a weak acid and the salt of the weak acid or a weak base and the salt of the weak base. Common buffer solutions include but are not limited to those comprising sodium carbonate, sodium citrate, sodium acetate, sodium diethyl barbituric, sodium bicarbonate, monobasic and dibasic sodium phosphate, dipotassium hydrogen phosphate, potassium dihydrogen phosphate, magnesium citrate, calcium citrate, potassium citrate, calcium carbonate, and calcium bicarbonate. The buffer system maintains the pH of a solution at the desired ranges. For example, but not by way of limitation, a buffer system assists to dissolve TAED prior to reacting TAED with hydrogen peroxide to generate PAA. In such a reaction, PAA has been found to generate faster at a higher pH.

In certain embodiments, the buffer system can also comprise a buffer or pH adjuster. Non-limiting examples of a pH adjuster can include acetic acid, diethyl barbituric acid, and citric acid. The pH adjuster can be used to lower pH to further stabilize hydrogen peroxide.

### 5.7. Sporicidal Disinfectant Compositions

The presently disclosed subject matter is directed to a sporicidal disinfectant comprising hydrogen peroxide and TAED to generate PAA that has prolonged stability and without an accompanying vinegar odor. Such a sporicidal disinfecting composition can comprise hydrogen peroxide, TAED, PAA, a stabilizer, and a buffer system.

In some embodiments, the composition can also have an additive. Additives can be at least one colorant, perfume, preservative, chelating agent, or solvent.

In certain embodiments, the sporicidal disinfecting composition can have about 0.001 wt % to about 65 wt % hydrogen peroxide. In some embodiments, the composition can have about 0.01 wt % to about 60 wt % hydrogen peroxide, and preferably about 8 wt % hydrogen peroxide. In further embodiments, the composition can have about 0.005 wt % to about 55 wt %, about 0.01 wt % to about 50 wt %, about 0.05 wt % to about 45 wt %, about 0.1 wt % to about 40 wt %, about 0.5 wt % to about 35 wt %, about 1 wt % to about 30 wt %, about 1.5 wt % to about 25 wt %, about 2 wt % to about 20 wt %, about 2.5 wt % to about 15 wt %, or about 3 wt % to about 10% hydrogen peroxide, or any range between any of these values.

In certain embodiments, the sporicidal disinfecting composition can have about 0.001 wt % to about 25 wt % TAED In some embodiments, the composition can have about 0.01 wt % to about 20 wt % TAED, and preferably about 2 wt % TAED. In further embodiments, the composition can have about 0.005 wt %, about 0.01 wt %, about 0.05 wt %, about 0.1 wt %, about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, about 15 wt %, about 15.5 wt %, about 16 wt %, about 16.5 wt %, about 17 wt %, about 17.5 wt %, about 18 wt %, about 18.5 wt %, about 19 wt %, about 19.5 wt %, or about 20 wt % TAED, or any range between any of these values.

In certain embodiments, the sporicidal disinfecting composition can have about 0.001 wt % to about 6 wt % or about 0.01 wt % to about 5 wt % of a stabilizer. In some embodiments, the composition can have about 0.01 wt %, about 0.05 wt %, about 0.1 wt %, about 0.15 wt %, about 0.2 wt %, about 0.25 wt %, about 0.3 wt %, about 0.35 wt %, about 0.4 wt %, about 0.45 wt %, about 0.5 wt %, about 0.55 wt %, about 0.6 wt %, about 0.65 wt %, about 0.7 wt %, about 0.75 wt %, about 0.8 wt %, about 0.85 wt %, about 0.9 wt %, about 0.95 wt %, or about 1 wt % of a stabilizer. In other embodiments, the composition can have about 1.5 wt %, about 2 wt %, about 2.5 wt %, about 3 wt %, about 3.5 wt %, about 4 wt %, about 4.5 wt %, or about 5 wt % of a stabilizer. In a preferred embodiment, the stabilizer comprises about 0.55 wt % of the composition.

In certain embodiments, the sporicidal disinfecting composition can have about 0.001 wt % to about 6 wt % or about 0.01 wt % to about 5 wt % of a buffer system. In some embodiments, the composition can have about 0.01 wt %, about 0.05 wt %, about 0.1 wt %, about 0.15 wt %, about 0.2 wt %, about 0.25 wt %, about 0.3 wt %, about 0.35 wt %, about 0.4 wt %, about 0.45 wt %, about 0.5 wt %, about 0.55 wt %, about 0.6 wt %, about 0.65 wt %, about 0.7 wt %, about 0.75 wt %, about 0.8 wt %, about 0.85 wt %, about 0.9 wt %, about 0.95 wt %, or about 1 wt % of a buffer system. In other embodiments, the composition can have about 1.5 wt %, about 2 wt %, about 2.5 wt %, about 3 wt %, about 3.5 wt %, about 4 wt %, about 4.5 wt %, or about 5 wt % of a buffer system. In certain embodiments, the buffer system can comprise sodium carbonate. In one embodiment, the sodium carbonate buffer system can comprise about 0.6 wt % of the composition. In certain embodiments, the buffer system can comprise sodium citrate. In one embodiment, the sodium citrate buffer system can comprise about 0.45 wt % of the composition.

In certain embodiments, the sporicidal disinfecting composition can comprise about 0.001 wt % to about 15 wt %, or about 0.01 wt % to about 10 wt %, or about 0.01 wt % to about 5 wt % of a buffer or pH adjuster. In some embodiments, the composition can have about 0.01 wt %, about 0.05 wt %, about 0.1 wt %, about 0.14 wt %, about 0.15 wt %, about 0.2 wt %, about 0.25 wt %, about 0.3 wt %, about 0.35 wt %, about 0.4 wt %, about 0.45 wt %, about 0.5 wt %, about 0.55 wt %, about 0.6 wt %, about 0.65 wt %, about 0.7 wt %, about 0.75 wt %, about 0.8 wt %, about 0.85 wt %, about 0.9 wt %, about 0.95 wt %, or about 1 wt % of a pH adjuster. In other embodiments, the composition can have about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of a pH adjuster. In certain embodiments, the pH adjuster can comprise acetic acid, citric acid, and/or combinations thereof. In certain embodiments, the pH adjuster can comprise about 0.01 wt % to about 10 wt % acetic acid and about 0.01 wt % to about 5 wt % citric acid. In certain embodiments, the pH adjuster can comprise about 0.05 wt % acetic acid. In certain embodiments, the pH adjuster can comprise about 0.1 wt % or about 0.14 wt % citric acid. In other embodiments, the pH adjuster can comprise a combination of about 0.05 wt % acetic acid and about 0.14 wt % citric acid, or a combination of about 0.05 wt % acetic acid and about 0.1 wt % citric acid.

In some embodiments, a method of treating an article or surface can include preparing the sporicidal disinfecting composition described herein. The method can also include contacting hydrogen peroxide with TAED to form PAA. In some embodiments, contacting the hydrogen peroxide with TAED can be in the presence of a stabilizer, a buffer system, a buffer or pH adjuster, and/or combinations thereof.

The sporicidal disinfecting composition can be used to treat, disinfect, or decontaminate an article or surface. In some embodiments, treating an article or surface can include treating hospital equipment with the composition. The sporicidal disinfecting composition can be applied using any techniques known in the art, including but not limiting to, spraying, brushing, dipping, and the like.

The presently disclosed sporicidal disinfecting compositions can be effective against a wide variety of microorganisms, including but not limited to bacteria, fungi, spores, yeasts, molds, mildews, protozoans, viruses, and so forth, including lipophilic, non-lipophilic, enveloped and naked RNA/DNA types. Thus, the presently disclosed compositions and methods are useful in reducing the microbial or viral populations on surfaces or objects, in liquids and gases, on the skin of humans and animals, on fabrics, and so forth. In certain embodiments, the ability to kill C. diff and other major bacteria or viruses, i.e., to reduce the amount of such bacteria or viruses by at least 99.9999%, is about three minutes. The disclosed subject matter can be utilized in cleaning and in a wide variety of other applications relating to the food industry, hospitality industry, medical industry, and so forth.

These applications are for illustrative purposes only and are not intended as a limitation on the scope of the presently disclosed subject matter. For example, in some embodiments, the disclosed compositions and methods can be used to treat hard surfaces. Hard surfaces include those surfaces comprised of metal, glass, ceramic, natural and synthetic rock, wood, and/or polymeric surfaces found on exposed environmental surfaces such as tables, floors, walls, and other mobile surfaces such as dishware including pots, pans, knives, forks, spoons, plates, dishes, food preparation equipment such as tanks, vats, lines, pumps, hoses, and other processing equipment.

The presently disclosed subject matter offers a stable composition. The stable composition offers enhanced shelf stability where the percentage of active hydrogen peroxide does not change by more than about 13% or the composition pH does not change by more than about 15% over a two-week period and at a temperature of about 54° C.

In yet another aspect, the present disclosure relates to consumer products comprising the sporicidal disinfectant compositions disclosed herein. In certain embodiments, the consumer product is a sporicidal disinfectant spray. In other embodiments, the consumer product is a sporicidal disinfectant wipe.

In certain embodiments, the sporicidal disinfectant spray comprises a sporicidal disinfectant composition disclosed herein and an apparatus for applying the sporicidal disinfectant composition. Any apparatus known in the art for holding a composition and applying it can be used with the present disclosure. In certain embodiments, the composition is a liquid composition. In certain embodiments, the liquid composition is a sporicidal disinfectant liquid composition.

In certain embodiments, the sporicidal disinfectant wipe comprises a sporicidal disinfectant composition disclosed herein, and an absorbent substrate impregnated with the sporicidal disinfectant composition. In certain embodiments, the sporicidal disinfectant wipe further comprises a sealed container containing the absorbent substrate.

Any absorbent substrate known in the art for holding a composition can be used with the present disclosure. In certain embodiments, the absorbent substrate is an absorbent nonwoven water-insoluble substrate. In certain embodiments, the absorbent substrate is a sheet, pad, mop, cloth, or multi-layer sponge product, and is meant for use by itself or may be associated with an applicator handle or holder. In certain embodiments, the absorbent substrate comprises a wiping pad suitable for wiping a substrate. In certain embodiments, the absorbent substrate is made from a material that resists disintegration while in use to effect a suitable wiping of a substrate. Non-limiting examples of the materials include natural fibers, synthetic fibers, paper, cotton, jute, rayon, viscose, lyocell, polyester, acrylonitrile, nylon, or a combination thereof. In certain embodiments, the absorbent substrate is made from 100% polyethylene terephthalate (PET). In certain embodiments, the absorbent substrate comprises a sponge material, polyurethane foam, or a combination thereof. In certain embodiments, the absorbent substrate is biodegradable. In certain embodiments, the absorbent substrate comprises a woven material, a non-woven material, or a combination thereof. In certain embodiments, the absorbent substrate has a surface area in the range from about 5 to about 2000 cm², or about 10 to about 1500 cm², or about 20 to about 1000 cm², or about 50 to about 750 cm², or about 75 to about 500 cm², or about 100 to about 250 cm². In certain embodiments, the absorbent substrate has a thickness that is sufficient to absorb and retain the aqueous composition. In certain embodiments, the absorbent substrate has a thickness in the range from about 0.01 to about 0.5 cm, or about 0.02 to about 0.4 cm, or about 0.05 to about 0.2 cm.

In certain embodiments, the basis weight of the absorbent substrate is from about 10 grams per square meter (gsm) to about 200 gsm, preferably from about 20 gsm to about 100 gsm. The higher basis weight range is preferred due to higher loading capacity and heavier duty abilities in a hospital setting.

In certain embodiments, the absorbent substrate is loaded with the disinfecting composition at the loading level from about 1.5 times the original weight of the wipe to about 10 times the original weight of the wipe, preferably from about 2.5 to about 7.5 original weight of the wipe, and more preferably from about 3 to about 6 original weight of the wipe.

Any shape known in the art for wipes can be used with the present disclosure. Non-limiting examples of shape of the disclosed wipes include circular, oval, square, rectangular, or irregularly shaped.

Each individual wipe can be arranged in a folded configuration and stacked one on top of the other to provide a stack of wet wipes. The folded configurations are well known to those skilled in the art and include c-folded, z-folded, quarter-folded configurations and so forth. Alternatively, the wipes can be configured as continuous wipes perforated in a stack or roll for dispensing. The wipes can consist of one or more layers including an optional scrub layer for maximum cleaning efficiency.

In certain embodiments, the absorbent substrate is folded to allow for storage in a sealed container. In certain embodiments, the sealed container is square or rectangular in shape. In certain embodiments, the sealed container has an air and liquid impermeable construction. In certain embodiments, the sealed container has a light impermeable construction. In certain embodiments, the sealed container is made from aluminum foil, plastic sheet, coated paper, or a combination thereof. In certain embodiments, the sealed container may be made from two non-porous sheets with common peripheral edges sealed together. In certain embodiments, the sealed container includes tear line and notch to facilitate tearing of the sealed container along the tear line. In certain embodiments, the sealed container has sufficient dimensions to allow for receiving the absorbent substrate.

### 6. EXAMPLES

The presently disclosed subject matter will be better understood by reference to the following Examples, which are provided as exemplary of the disclosed subject matter, and not by way of limitation.

### Example 1: Manufacturing Process

This example describes a manufacturing process of formulation a sporicidal disinfectant composition as described in the present disclosure.

### Steps:

1. Different buffer solutions were prepared with sodium carbonate and sodium citrate with a pH range of 6-8.
2. TAED was added to the buffer solutions and dissolved.
3. After the TAED dissolved, hydrogen peroxide was added and mixed for about 40 minutes to generate peracetic acid (PAA).
4. Acetic acid and citric acid were added as buffers/pH adjusters to bring the pH down to between about 3.5-6 to stabilize the hydrogen peroxide.
5. HEDP was added and mixed for about 30-45 minutes to help stabilize the composition.

Non-limiting examples of sporicidal disinfectant compositions are shown in Table 1 below.

TABLE 1

| | Weight % | |
|---|---|---|
| Raw Material | Composition #1 | Composition #2 |
| Water | 88.66 | 88.85 |
| TAED | 2.00 | 2.00 |
| Sodium Carbonate | 0.60 | * |
| Sodium Citrate | * | 0.45 |
| H₂O₂ (50%) | 8.00 | 8.00 |
| Acetic Acid | 0.05 | 0.05 |
| Citric Acid | 0.14 | 0.10 |
| HEDP | 0.55 | 0.55 |
| Total | 100.00 | 100.00 |

### Example 2: Hydrogen Peroxide Stability

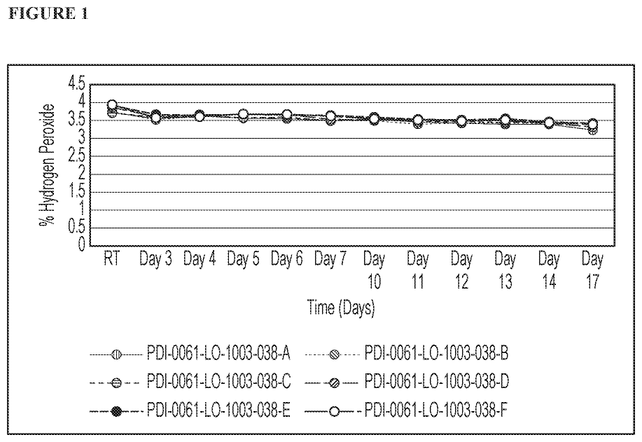

This example is a study conducted to observe the stability of hydrogen peroxide as measured by changes in hydrogen peroxide wt % (Table 2) and composition pH (Table 3). FIG. 1 is a graphic representation of the results tabulated in Table 2.

Six sporicidal disinfectant compositions formulated in accordance with the present disclosure, respectively labeled A, B, C, D, E, and F, were measured every day for pH and for the amount of hydrogen peroxide present. The compositions were consistently maintained at a high temperature of 54° C. Measurements were taken starting on Day 1, and then Day 3 continuing through Day 17. The overall change (A) was assessed between Day 1 and Day 14. The results of this example show that the compositions have stable shelf life over two weeks and at a high temperature.

TABLE 2
Stability Study - Weight % of H₂O₂

| | Day 1 | Day 3 | Day 4 | Day 5 | Day 6 | Day 7 | Day 10 | Day 11 | Day 12 | Day 13 | Day 14 | Day 17 | Δ |
|---|---|---|---|---|---|---|---|---|---|---|---|---|---|
| A | 3.72 | 3.55 | 3.63 | 3.56 | 3.55 | 3.49 | 3.53 | 3.46 | 3.42 | 3.39 | 3.39 | 3.23 | 0.33 |
| B | 3.74 | 3.52 | 3.62 | 3.56 | 3.59 | 3.5 | 3.49 | 3.4 | 3.43 | 3.43 | 3.41 | 3.32 | 0.33 |
| C | 3.71 | 3.59 | 3.65 | 3.57 | 3.59 | 3.49 | 3.53 | 3.46 | 3.47 | 3.44 | 3.46 | 3.38 | 0.25 |
| D | 3.86 | 3.61 | 3.66 | 3.66 | 3.66 | 3.53 | 3.52 | 3.53 | 3.5 | 3.49 | 3.42 | 3.32 | 0.44 |
| E | 3.92 | 3.66 | 3.64 | 3.67 | 3.65 | 3.64 | 3.59 | 3.53 | 3.51 | 3.55 | 3.46 | 3.42 | 0.46 |
| F | 3.94 | 3.57 | 3.6 | 3.68 | 3.67 | 3.62 | 3.54 | 3.51 | 3.48 | 3.51 | 3.44 | 3.39 | 0.5 |

TABLE 3
Stability Study - Change in pH

| | Day 1 | Day 3 | Day 4 | Day 5 | Day 6 | Day 7 | Day 10 | Day 11 | Day 12 | Day 13 | Day 14 | Day 17 | Δ |
|---|---|---|---|---|---|---|---|---|---|---|---|---|---|
| A | 5.03 | 4.34 | 4.25 | 4.24 | 4.3 | 4.3 | 4.34 | 4.33 | 4.34 | 4.35 | 4.28 | 4.33 | 0.75 |
| B | 5.03 | 4.36 | 4.28 | 4.25 | 4.3 | 4.32 | 4.35 | 4.34 | 4.36 | 4.35 | 4.28 | 4.35 | 0.75 |
| C | 5.03 | 4.34 | 4.25 | 4.25 | 4.27 | 4.28 | 4.35 | 4.33 | 4.33 | 4.37 | 4.28 | 4.33 | 0.75 |
| D | 3.3 | 3.22 | 3.15 | 3.14 | 3.3 | 3.34 | 3.49 | 3.51 | 3.54 | 3.61 | 3.51 | 3.6 | −0.21 |
| E | 3.26 | 3.2 | 3.12 | 3.18 | 3.28 | 3.39 | 3.45 | 3.48 | 3.54 | 3.58 | 3.48 | 3.66 | −0.18 |
| F | 3.26 | 3.2 | 3.13 | 3.18 | 3.28 | 3.37 | 3.45 | 3.49 | 3.55 | 3.56 | 3.48 | 3.59 | −0.22 |

### Example 3: C. Difficile Elimination

This example is a study conducted to assess the effectiveness of the present disclosure to eliminate Clostridium difficile (C. diff) spores from a stainless-steel surface. Two formulations, Batch A and Batch B, were tested on 304 stainless steel (304 ss) and 430 stainless (430 ss) steel disks. The formulation of Batch A and Batch B are tabulated in Table 4 below:

TABLE 4

| | Weight % | |
|---|---|---|
| Raw Material | Batch A | Batch B |
| Water | 88.85 | 88.45 |
| TAED | 2.00 | 2.20 |
| Sodium Carbonate | * | * |
| Sodium Citrate | 0.45 | 0.45 |
| H₂O₂ (50%) | 8.00 | 8.20 |
| Acetic Acid | 0.05 | 0.05 |
| Citric Acid | 0.10 | 0.10 |
| HEDP | 0.55 | 0.55 |
| Total | 100.00 | 100.00 |

A spore suspension of C. diff was prepared according to ASTM E2839-11. The spores were confirmed for spore purity and resistance to 2.5 M (N) HCl prior to use in testing. The spores were adjusted to target 2×10⁸ to 8×10⁸ spores/mL and stored at −20±5° C. for four days prior to use.

A 10 μL film of bacterial spores was dried on the surface of a brushed stainless-steel disk (diameter of 1 cm, thickness of 0.7 mm). 50 μL of the sporicidal disinfectant of the present disclosure was applied to the center of each C. diff disk, covering the entire inoculated area with the sporicidal disinfectant. The treated disk was held at set exposure temperature for a specified exposure time.

After exposure, the disks were neutralized using 10 mL of neutralizer, vortex mixed for at least 30±5 seconds, and quantitatively assayed for survivors using 0.2 μm polyethersulfone filter membranes. Appropriate culture purity, carrier sterility, organic soil load sterility, neutralizer sterility, spore titer (including spore purity), carrier population, HCl resistance, and neutralization confirmation were performed.

Both Batch A and Batch B ready-to-use samples respectively demonstrated a >99.9999% (>6.36 Log₁₀) and a >99.9999% (>6.46 Log₁₀) reduction using 304 ss disks, and a >99.9999% (>6.25 Log₁₀) and a >99.9999% (>6.26 Log₁₀) reduction using 430 ss disks of C. diff following a three-minute exposure time when tested at room temperature (22° C.) in the presence of a 0.25% Bovine Serum Albumin, 0.08% Bovine Mucin, and 0.35% Yeast Extract organic soil load. The results are summarized in Table 5 (304 stainless steel disks) and Table 6 (430 stainless steel disks) below.

TABLE 5

| | | * Final # C. | Test Disk | Control | Percent |
|---|---|---|---|---|---|
| | | diff on Test | Average # | Average # | Reduction |
| | 304 ss | Disk | of C. diff | of C. diff | (Log₁₀ |
| Batch | Disk # | (Log₁₀) | (Log₁₀) | (Log₁₀) | Reduction) |
| A | 1 | <1 | <1.26 × 10⁰ | 2.88 × 10⁶ | >99.9999% |
| | | (<0.00) | (<0.10) | (6.46) | (>6.36) |
| | 2 | <1 | | | |
| | | (<0.00) | | | |
| | 3 | <1 | | | |
| | | (<0.00) | | | |
| | 4 | <9 | | | |
| | | (<0.95) | | | |
| | 5 | <1 | | | |
| | | (<0.00) | | | |
| | 6 | <1 | | | |
| | | (<0.00) | | | |
| | 7 | <1 | | | |
| | | (<0.00) | | | |
| | 8 | <1 | | | |
| | | (<0.00) | | | |
| | 9 | <1 | | | |
| | | (<0.00) | | | |
| | 10 | <1 | | | |
| | | (<0.00) | | | |
| B | 1 | <1 | <1 | 2.88 × 10⁶ | >99.9999% |
| | | (<0.00) | (<0.00) | (6.46) | (>6.46) |
| | 2 | <1 | | | |
| | | (<0.00) | | | |
| | 3 | <1 | | | |
| | | (<0.00) | | | |
| | 4 | <1 | | | |
| | | (<0.00) | | | |
| | 5 | <1 | | | |
| | | (<0.00) | | | |
| | 6 | <1 | | | |
| | | (<0.00) | | | |
| | 7 | <1 | | | |
| | | (<0.00) | | | |
| | 8 | <1 | | | |
| | | (<0.00) | | | |
| | 9 | <1 | | | |
| | | (<0.00) | | | |
| | 10 | <1 | | | |
| | | (<0.00) | | | |

* A value of <1 was used in place of zero for calculation purposes.

TABLE 6

| | | * Final # C. | Test Disk | Control | Percent |
|---|---|---|---|---|---|
| | | diff on Test | Average # | Average # | Reduction |
| | 304 ss | Disk | of C. diff | of C. diff | (Log₁₀ |
| Batch | Disk # | (Log₁₀) | (Log₁₀) | (Log₁₀) | Reduction) |
| A | 1 | 4.4 × 10¹ | <1.45 × 10⁰ | 2.5 × 10⁶ | >999999% |
| | | (1.64) | (<0.16) | (6.41) | (>6.25) |
| | 2 | <1 | | | |
| | | (<0.00) | | | |
| | 3 | <1 | | | |
| | | (<0.00) | | | |
| | 4 | <9 | | | |
| | | (<0.95) | | | |
| | 5 | <1 | | | |
| | | (<0.00) | | | |
| | 6 | <1 | | | |
| | | (<0.00) | | | |
| | 7 | <1 | | | |
| | | (<0.00) | | | |
| | 8 | <1 | | | |
| | | (<0.00) | | | |
| | 9 | <1 | | | |
| | | (<0.00) | | | |
| | 10 | <1 | | | |
| | | (<0.00) | | | |
| B | 1 | <1 | <1.16 × 10⁰ | 2.57 × 10⁶ | >99.9999% |
| | | (<0.00) | (<0.15) | (6.41) | (>6.26) |
| | 2 | 3.2 × 10¹ | | | |
| | | (1.51) | | | |
| | 3 | <1 | | | |
| | | (<0.00) | | | |
| | 4 | <1 | | | |
| | | (<0.00) | | | |
| | 5 | <1 | | | |
| | | (<0.00) | | | |
| | 6 | <1 | | | |
| | | (<0.00) | | | |
| | 7 | <1 | | | |
| | | (<0.00) | | | |
| | 8 | <1 | | | |
| | | (<0.00) | | | |
| | 9 | <1 | | | |
| | | (<0.00) | | | |
| | 10 | <1 | | | |
| | | (<0.00) | | | |

* A value of <1 was used in place of zero for calculation purposes.

### Example 4: Hydrogen Peroxide and Peracetic Acid Content

Four sporicidal disinfectant samples (A, B, C, and D) formulated in accordance with the present disclosure, were measured at day 0 and after 24 hours or 14 days for pH and for the amount of hydrogen peroxide and peracetic acid present. Two replicates from each sample were taken. Analyses of the compositions were conducted initially (day 0), after 24 hours at room temperature and 90° C., and after 14 days at room temperature and 54° C. The measurements and results were shown in Tables 7-11.

TABLE 7
Measurements from Day 0

| | | % Hydrogen | % Peroxyacetic | % | |
|---|---|---|---|---|---|
| Sample | Replicate | Peroxide | Acid | Total | pH |
| A | 1 | 4.46 | 0.18 | | 3.70 |
| | 2 | 4.41 | 0.16 | | |
| | Average | 4.43 | 0.17 | 4.60 | |
| B | 1 | 4.44 | 0.19 | | 3.64 |
| | 2 | 4.42 | 0.20 | | |
| | Average | 4.43 | 0.19 | 4.62 | |
| C | 1 | 4.44 | 0.19 | | 3.40 |
| | 2 | 4.42 | 0.18 | | |
| | Average | 4.43 | 0.19 | 4.62 | |
| D | 1 | 4.37 | 0.12 | | 4.09 |
| | 2 | 4.38 | 0.16 | | |
| | Average | 4.38 | 0.14 | 4.52 | |

TABLE 8
Measurements from After 24 Hours at Room Temperature

| | | % Hydrogen | % Peroxyacetic | % | |
|---|---|---|---|---|---|
| Sample | Replicate | Peroxide | Acid | Total | pH |
| A | 1 | 4.42 | 0.21 | | 3.66 |
| | 2 | 4.37 | 0.18 | | |
| | Average | 4.39 | 0.18 | 4.59 | |
| B | 1 | 4.42 | 0.20 | | 3.64 |
| | 2 | 4.41 | 0.21 | | |
| | Average | 4.41 | 0.20 | 4.62 | |
| C | 1 | 4.43 | 0.14 | | 3.38 |
| | 2 | 4.42 | 0.17 | | |
| | Average | 4.43 | 0.15 | 4.58 | |
| D | 1 | 4.34 | 0.21 | | 4.09 |
| | 2 | 4.32 | 0.24 | | |
| | Average | 4.33 | 0.23 | 4.56 | |

TABLE 9
Measurements from After 24 Hours at 90° C.

| | | % Hydrogen | % Peroxyacetic | % | |
|---|---|---|---|---|---|
| Sample | Replicate | Peroxide | Acid | Total | pH |
| A | 1 | 3.18 | 0.13 | | 3.70 |
| | 2 | 3.19 | 0.16 | | |
| | Average | 3.18 | 0.14 | 3.33 | |
| B | 1 | 2.76 | 0.11 | | 3.69 |
| | 2 | 2.74 | 0.10 | | |
| | Average | 2.75 | 0.11 | 2.86 | |
| C | 1 | 3.85 | 0.21 | | 3.49 |
| | 2 | 3.86 | 0.21 | | |
| | Average | 3.86 | 0.21 | 4.07 | |
| D | 1 | 2.38 | 0.08 | | 4.11 |
| | 2 | 2.40 | 0.13 | | |
| | Average | 2.39 | 0.11 | 2.49 | |

TABLE 10
Measurements from After 14 Days at Room Temperature

| | | % Hydrogen | % Peroxyacetic | % | |
|---|---|---|---|---|---|
| Sample | Replicate | Peroxide | Acid | Total | pH |
| A | 1 | 4.25 | 0.22 | | 3.70 |
| | 2 | 4.24 | 0.22 | | |
| | Average | 4.24 | 0.22 | 4.47 | |
| B | 1 | 4.27 | 0.25 | | 3.64 |
| | 2 | 4.24 | 0.27 | | |
| | Average | 4.26 | 0.26 | 4.52 | |
| C | 1 | 4.34 | 0.27 | | 3.41 |
| | 2 | 4.33 | 0.24 | | |
| | Average | 4.33 | 0.25 | 4.59 | |
| D | 1 | 4.14 | 0.28 | | 4.12 |
| | 2 | 4.14 | 0.23 | | |
| | Average | 4.14 | 0.25 | 4.39 | |

TABLE 11
Measurements from After 14 Days At 54° C.

| | | % Hydrogen | % Peroxyacetic | % | |
|---|---|---|---|---|---|
| Sample | Replicate | Peroxide | Acid | Total | pH |
| A | 1 | 3.25 | 0.25 | | 3.69 |
| | 2 | 3.26 | 0.21 | | |
| | Average | 3.26 | 0.23 | 3.49 | |
| B | 1 | 3.25 | 0.21 | | 3.67 |
| | 2 | 3.29 | 0.20 | | |
| | Average | 3.27 | 0.20 | 3.48 | |
| C | 1 | 3.74 | 0.27 | | 3.44 |
| | 2 | 3.38 | 0.21 | | |
| | Average | 3.56 | 0.24 | 3.80 | |
| D | 1 | 2.17 | 0.18 | | 4.14 |
| | 2 | 2.20 | 0.14 | | |
| | Average | 2.19 | 0.16 | 2.34 | |

### Example 5: Stability Studies of Wipes and Sprays

This study was conducted to determine the hydrogen peroxide content and its stability in the spray and wipe samples comprising sporicidal disinfectant compositions disclosed herein. Two sprays (G and H) were tested in this study. Additionally, one wipe (I) was tested in this study.

Hydrogen peroxide content (wt. %) in the spray samples was measured over a 13-week period at 40° C., and the average test results were presented in Table 12. Hydrogen peroxide content (wt. %) in the wipe samples was measured over a 2-week at 54° C., and the average test results were presented in Table 13. The wipe samples were 50 grams per square meter (gsm) and the absorbent sheets of the wipe were made from 100% polyethylene terephthalate (PET).

TABLE 12
Hydrogen Peroxide Content in Spray Samples (Average Test Results)

| | Spray G | Spray H | % Recovery |
|---|---|---|---|
| Initial Results | 6.03 | 6.02 | 100.4 |
| 1-week | 5.96 | 5.93 | 99.3 |
| 3-weeks | 5.79 | 5.74 | 96.4 |
| 5-weeks | 5.74 | 5.74 | 95.7 |
| 7-weeks | 5.63 | 5.64 | 93.8 |
| 9-weeks | 5.46 | 5.48 | 90.9 |
| 11-weeks | 5.35 | 5.39 | 89.2 |
| 13-weeks | 5.23 | 5.28 | 87.2 |

TABLE 13
Hydrogen Peroxide Content in Wipe Samples (54° C./2 weeks
Studies—50 gsm 100% PET

| | Wipe I | % Recovery |
|---|---|---|
| Initial Results | 5.91 | 98.5 |
| 1-week | 5.22 | 87.0 |
| 2-weeks | 4.89 | 81.5 |

Although the presently disclosed subject matter and its advantages have been described in detail, it should be understood that various changes, substitutions and alterations can be made herein without departing from the spirit and scope of the disclosed subject matter as defined by the appended claims. Moreover, the scope of the present disclosure is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

Patents, patent applications publications product descriptions, and protocols are cited throughout this application the disclosures of which are incorporated herein by reference in their entireties for all purposes.

1. A sporicidal disinfectant composition comprising hydrogen peroxide and tetraacetylethylenediamine (TAED), wherein the composition is formulated as a single solution.

2. The sporicidal disinfectant composition of claim 1, wherein the hydrogen peroxide is between about 0.1 wt % and about 60 wt % of the composition.

3. The sporicidal disinfectant composition of claim 1, wherein the TAED is between about 0.01 wt % and about 20 wt % of the composition.

4. The sporicidal disinfectant composition of claim 1, wherein the composition reduces the amount of Clostridium difficile (C. diff) on an article or on a surface by at least about 99.9999% in about 3 minutes.

5. The sporicidal disinfectant composition of claim 1, further comprising a buffer system.

6. The sporicidal disinfectant composition of claim 5, wherein the buffer system is about 0.01 wt % to about 5 wt % of the composition.

7. The sporicidal disinfectant composition of claim 5, wherein the buffer system comprises at least one of sodium carbonate or sodium citrate.

8. The sporicidal disinfectant composition of claim 7, wherein the sodium carbonate is about 0.6 wt % of the composition.

9. The sporicidal disinfectant composition of claim 1, further comprising a pH adjuster.

10. The sporicidal disinfectant composition of claim 9, wherein the pH adjuster comprises acetic acid and citric acid.

11. The sporicidal disinfectant composition of claim 10, wherein the acetic acid is about 0.01 wt % to about 10 wt % of the composition and the citric acid is about 0.01 wt % to about 5 wt % of the composition.

12. The sporicidal disinfectant composition of claim 11, wherein the acetic acid is about 0.05 wt % of the composition and the citric acid is about 0.10 wt % of the composition.

13. The sporicidal disinfectant composition of claim 1, further comprising a stabilizer.

14. The sporicidal disinfectant composition of claim 13, wherein the stabilizer comprises hydroxyethane 1,1-diphosphonic acid (HEDP).

15. The sporicidal disinfectant composition of claim 13, wherein the stabilizer is about 0.01 wt % to about 5 wt % of the composition.

16. The sporicidal disinfectant composition of claim 15, wherein the stabilizer is about 0.55 wt % of the composition.

17. A consumer product comprising the sporicidal disinfectant composition of claim 1.

18. A method of disinfecting an article or surface comprising treating said article or surface with the sporicidal disinfectant composition of claim 1.

19. The consumer product of claim 18, wherein the consumer product comprises at least one of a sporicidal disinfectant spray or a sporicidal disinfectant wipe.

20. The consumer product of claim 19, wherein the sporicidal disinfectant spray comprises an apparatus for applying the sporicidal disinfectant composition to a surface.
